(19) United States
(12) Patent Application Publication
(10) Pub. No.: US 2016/0127936 A1
(43) Pub. Date: May 5, 2016

(54) USER EQUIPMENT AND METHODS FOR CSI MEASUREMENTS WITH REDUCED BANDWIDTH SUPPORT

(71) Applicants: Debdeep Chatterjee, Santa Clara, CA (US); Seunghee Han, Cupertino, CA (US); Alexei Davydov, Nizhny Novgorod (RU); Gang Xiong, Beaverton, OR (US); Yuan Zhu, Beijing (CN)

(72) Inventors: Debdeep Chatterjee, Santa Clara, CA (US); Seunghee Han, Cupertino, CA (US); Alexei Davydov, Nizhny Novgorod (RU); Gang Xiong, Beaverton, OR (US); Yuan Zhu, Beijing (CN)

(21) Appl. No.: 14/711,866

(22) Filed: May 14, 2015

Related U.S. Application Data
(60) Provisional application No. 62/075,722, filed on Nov. 5, 2014.

(51) Int. Cl. H04W 24/10; H04W 4/00; H04B 7/06

(52) U.S. Cl. CPC H04W 24/10; H04B 7/0626; H04B 7/0632; H04W 4/005

(57) ABSTRACT

An enhanced NodeB (eNB), user equipment (UE) and method of Channel State Information (CSI) measurement and reporting using reduced bandwidth are generally described herein. The UE is preconfigured with a resource configuration information or the configuration information is transmitted to the UE from the eNB. The configuration information indicates a narrowband region on which to monitor for and receive physical downlink control and data channels and perform measurements for CSI computation. The region has a reduced bandwidth that is supported by the UE and is free from subbands outside of the region. The UE takes measurements of downlink transmissions using the assigned resources. The measurements are limited to subbands included within the region. The UE calculates the CSI based on an unrestricted time interval within subframes of the region and a restricted frequency interval free from physical resource blocks outside the region. The UE reports a region-specific wideband CSI that includes at least a region-specific wideband Channel Quality Indicator to the eNB.

### PRIORITY CLAIM

This application claims the benefit of priority to U.S. Provisional Patent Application Ser. No. 62/075,722, filed Nov. 5, 2014, which is incorporated herein by reference in its entirety.

### TECHNICAL FIELD

Embodiments pertain to radio access networks. Some embodiments relate to system reports for radio access networks, including Third Generation Partnership Project Long Term Evolution (3GPP LTE) networks and LTE advanced (LTE-A) networks as well as 4^{th} generation (4G) networks and 5^{th} generation (5G) networks. Some embodiments relate to reports that use resource allocation on a limited bandwidth.

### BACKGROUND

With the increase in different types of devices communicating over networks to servers and other computing devices, usage of third generation long term evolution (3GPP LTE) systems has increased. In particular, both typical user equipment (UE) such as cell phones and Machine Type Communication (MTC) devices currently use a 3GPP LTE system. To reduce the power and cost of MTC UEs, the MTC UEs may use a reduced bandwidth for communication with the serving base station (enhanced Node B (eNB)). This may cause issues with the ability of MTC UEs to communicate using normal Radio Link Control (RLC) protocol requirements within the current 3GPP standard, e.g., Release 12 (3GPP TS 36.213). In particular, the UEs provide periodic reports, based on measurements taken by the UE, long-term and short-term link conditions. At least some of these reports under the current 3GPP standard, however, depend on the UE having access to the entire radio frequency (RF) spectrum used by the eNB and are thus incompatible with the limited bandwidth available to MTC UEs.

It would be therefore desirable for a network to enable a UE, and the UE, to provide system reports using a limited bandwidth range.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 shows an example of a portion of an end-to-end network architecture of an LTE network with various components of the network in accordance with some embodiments.

FIG. 2 illustrates a functional block diagram of an eNB in accordance with some embodiments in accordance with some embodiments.

FIGS. 3A-3C illustrate resource blocks in accordance with some embodiments.

FIGS. 4A and 4B illustrate a frame in accordance with some embodiments.

FIG. 5 illustrates a flowchart of a method of providing channel feedback in accordance with some embodiments.

### DETAILED DESCRIPTION OF THE INVENTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

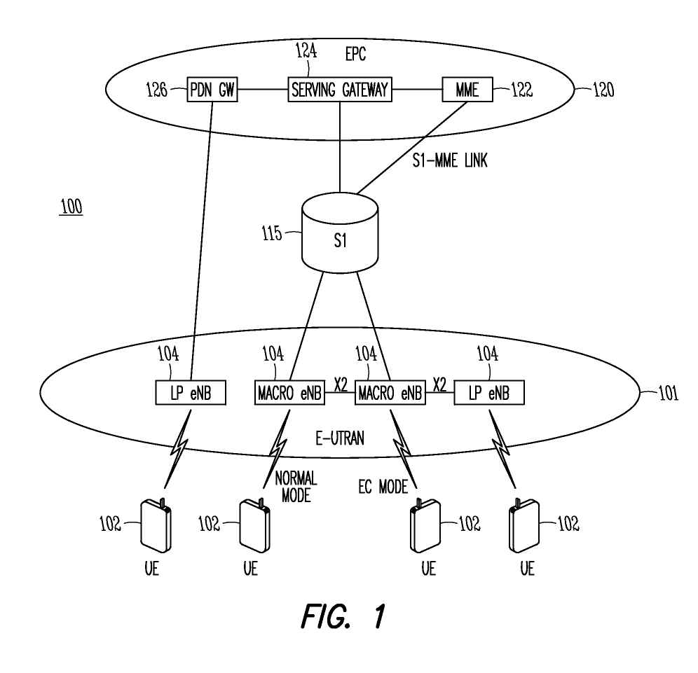

FIG. 1 shows an example of a portion of an end-to-end network architecture of a long term evolution (LTE) network with various components of the network in accordance with some embodiments. The network 100 may comprise a radio access network (RAN) (e.g., as depicted, the E-UTRAN or evolved universal terrestrial radio access network) 101 and the core network 120 (e.g., shown as an evolved packet core (EPC)) coupled together through an S1 interface 115. For convenience and brevity, only a portion of the core network 120, as well as the RAN 101, is shown in the example.

The core network 120 may include mobility management entity (MME) 122, serving gateway (serving GW) 124, and packet data network gateway (PDN GW) 126. The RAN 101 includes evolved node-Bs (eNBs) 104 (which may operate as base stations) for communicating with user equipment (UE) 102. The eNBs 104 may include macro eNBs and low power (LP) eNBs. The UEs 102 may include narrowband UEs as well as standard band UEs. The operation of the narrowband UEs is described in more detail below.

The MME 122 may be similar in function to the control plane of legacy Serving GPRS Support Nodes (SGSN). The MME 122 may manage mobility aspects in access such as gateway selection and tracking area list management. The serving GW 124 may terminate the interface toward the RAN 101, and route data packets between the RAN 101 and the core network 120. In addition, the serving GW 124 may be a local mobility anchor point for inter-eNB handovers and also may provide an anchor for inter-3GPP mobility. Other responsibilities may include lawful intercept, charging, and some policy enforcement. The serving GW 124 and the MME 122 may be implemented in one physical node or separate physical nodes. The PDN GW 126 may terminate an SGi interface toward the packet data network (PDN). The PDN GW 126 may route data packets between the EPC 120 and the external PDN, and may perform policy enforcement and charging data collection. The PDN GW 126 may also provide an anchor point for mobility devices with non-LTE access. The external PDN may be any kind of IP network, as well as an IP Multimedia Subsystem (IMS) domain. The PDN GW 126 and the serving GW 124 may be implemented in a single physical node or separate physical nodes.

The PDN GW 126 and MME 122 may also be connected to a location server 130. The UE and eNB may communicate with the location server 130 via the user plane (U-Plane) and/or control plane (C-Plane). The location server 130 may be a physical or logical entity that may collect measurement data and other location information from the UE 102 and eNB 104 and assist the UE 102 with an estimation of the position of the UE 102, providing a calculation of the network-based location, as indicated in more detail below.

The eNBs 104 (macro and micro) may terminate the air interface protocol and may be the first point of contact for a UE 102. In some embodiments, an eNB 104 may fulfill various logical functions for the RAN 101 including but not limited to RNC (radio network controller functions) such as radio bearer management, uplink and downlink dynamic radio resource management and data packet scheduling, and mobility management. In accordance with embodiments, UEs 102 may be configured to communicate OFDM communication signals with an eNB 104 over a multicarrier communication channel in accordance with an OFDMA communication technique. The OFDM signals may comprise a plurality of orthogonal subcarriers.

The S1 interface 115 may be the interface that separates the RAN 101 and the EPC 120. It may be split into two parts: the S1-U, which may carry traffic data between the eNBs 104 and the serving GW 124, and the S1-MME, which may be a signaling interface between the eNBs 104 and the MME 122. The X2 interface may be the interface between eNBs 104. The X2 interface may comprise two parts, the X2-C and X2-U. The X2-C may be the control plane interface between the eNBs 104, while the X2-U may be the user plane interface between the eNBs 104.

With cellular networks, LP cells may be typically used to extend coverage to indoor areas where outdoor signals do not reach well, or to add network capacity in areas with dense usage. In particular, it may be desirable to enhance the coverage of a wireless communication system using cells of different sizes, macrocells, microcells, picocells, and femtocells, to boost system performance. The cells of different sizes may operate on the same frequency band, such as the LTE unlicensed band, or may operate on different frequency bands with each cell operating in a different frequency band or only cells of different sizes operating on different frequency bands. As used herein, the term low power (LP) eNB refers to any suitable relatively low power eNB for implementing a narrower cell (narrower than a macro cell) such as a femtocell, a picocell, or a microcell. Femtocell eNBs may be typically provided by a mobile network operator to its residential or enterprise customers. A femtocell may be typically the size of a residential gateway or smaller and generally may connect to the user's broadband line. The femtocell may connect to the mobile operator's mobile network and provide extra coverage in a range of typically 30 to 50 meters. Thus, a LP eNB may be a femtocell eNB since it is coupled through the PDN GW 126. Similarly, a picocell may be a wireless communication system typically covering a small area, such as in-building (offices, shopping malls, train stations, etc.), or more recently in-aircraft. A picocell eNB may generally connect through the X2 link to another eNB such as a macro eNB through its base station controller (BSC) functionality. Thus, LP eNB may be implemented with a picocell eNB since it is coupled to a macro eNB via an X2 interface. Picocell eNBs or other LP eNBs may incorporate some or all functionality of a macro eNB. In some cases, this may be referred to as an access point base station or enterprise femtocell.

Communication over an LTE network is split up into 10 ms frames, each of which contains ten 1 ms subframes. Each subframe, in turn, may contain two slots of 0.5 ms. Each slot may contain 6-7 symbols, depending on the system used. A resource block (RB) may be the smallest unit of resources that can be allocated to a UE. A resource block may be 180 kHz wide in frequency and 1 slot long in time. In frequency, resource blocks may be either 12×15 kHz subcarriers or 24×7.5 kHz subcarriers wide. For most channels and signals, 12 subcarriers may be used per resource block. In Frequency Division Duplexed (FDD) mode, both the uplink and downlink frames may be 10 ms and frequency (full-duplex) or time (half-duplex) separated. In Time Division Duplexed (TDD), the uplink and downlink subframes may be transmitted on the same frequency and multiplexed in the time domain. A downlink resource grid may be used for downlink transmissions from an eNB to a UE. The grid may be a time-frequency grid, which is the physical resource in the downlink in each slot. Each column and each row of the resource grid may correspond to one OFDM symbol and one OFDM subcarrier, respectively. The duration of the resource grid in the time domain may correspond to one slot. The smallest time-frequency unit in a resource grid may be denoted as a resource element. Each resource grid may comprise a number of the above resource blocks, which describe the mapping of certain physical channels to resource elements. Each resource block may comprise 12 (subcarriers)*14 (symbols)=168 resource elements. Particular physical resource blocks in a frame may be indicated to UEs by the eNB using physical resource block indices, so that a UE may be allocated one or more physical resource blocks for uplink communications, such as transmitting measurement data used by the network to estimate conditions of a channel being measured.

There are several different physical downlink channels that may be conveyed using such resource blocks. Two of these physical downlink channels may be the physical down link control channel (PDCCH) and the physical downlink shared channel (PDSCH). Each subframe may be partitioned into the PDCCH and the PDSCH. The PDCCH may normally occupy the first two symbols of each subframe and carry, among other things, information about the transport format and resource allocations related to the PDSCH channel, as well as H-ARQ information related to the uplink shared channel. The PDSCH may carry user data and higher-layer signaling to a UE and occupy the remainder of the subframe. Typically, downlink scheduling (assigning control and shared channel resource blocks to UEs within a cell) may be performed at the eNB based on channel quality information provided from the UEs to the eNB, and then the downlink resource assignment information may be sent to each UE on the PDCCH used for (assigned to) the UE. The PDCCH may contain downlink control information (DCI) in one of a number of formats that tell the UE how to find and decode data, transmitted on PDSCH in the same subframe, from the resource grid. The DCI format may provide details such as number of resource blocks, resource allocation type, modulation scheme, transport block, redundancy version, coding rate etc. Each DCI format may have a cyclic redundancy code (CRC) and be scrambled with a Radio Network Temporary Identifier (RNTI) that identifies the target UE for which the PDSCH is intended. Use of the UE-specific RNTI may limit decoding of the DCI format (and hence the corresponding PDSCH) to only the intended UE.

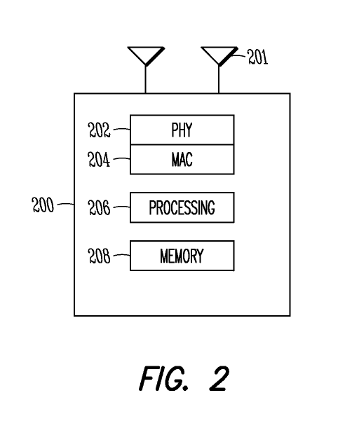

FIG. 2 illustrates a functional block diagram of a communication device in accordance with some embodiments. The communication device 200 may be an UE or eNB and may include physical layer (PHY) circuitry 202 for transmitting and receiving radio frequency electrical signals to and from the communication device, other eNBs, other UEs or other devices using one or more antennas 201 electrically connected to the PHY circuitry. The PHY circuitry 202 may include circuitry for modulation/demodulation, upconversion/downconversion, filtering, amplification, etc. The communication device 200 may also include medium access control layer (MAC) circuitry 204 for controlling access to the wireless medium and to configure frames or packets for communicating over the wireless medium. The communication device 200 may also include processing circuitry 206 and memory 208 arranged to configure the various elements of the cellular device to perform the operations described herein. The memory 208 may be used to store information for configuring the processing circuitry 206 to perform the operations.

In some embodiments, the communication device 200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable device, a sensor, or other device that may receive and/or transmit information wirelessly. In some embodiments, the communication device 200 may include one or more of a keyboard, a display, a non-volatile memory port, multiple antennas, a graphics processor, an application processor, speakers, and other mobile device elements. The display may be an LCD screen including a touch screen.

The one or more antennas 201 utilized by the communication device 200 may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated to take advantage of spatial diversity and different channel characteristics that may result between each of the antennas of a receiving station and each of the antennas of a transmitting station. In some MIMO embodiments, the antennas may be separated by up to 1/10 of a wavelength or more.

Although the communication device 200 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

The embodiments described may be implemented in one or a combination of hardware, firmware and software. Embodiments may also be implemented as instructions stored on a computer-readable storage medium, which may be read and executed by at least one processor to perform the operations described herein. A computer-readable storage medium may include any non-transitory mechanism for storing information in a form readable by a machine (e.g., a computer). For example, a computer-readable storage medium may include read-only memory (ROM), random-access memory (RAM), magnetic disk storage media, optical storage media, flash-memory devices, and other storage devices and media. In these embodiments, one or more processors may be configured with the instructions to perform the operations described herein.

In some embodiments, the processing circuitry 206 may be configured to receive OFDM communication signals over a multicarrier communication channel in accordance with an OFDMA communication technique. The OFDM signals may comprise a plurality of orthogonal subcarriers. In some broadband multicarrier embodiments, the cellular device 200 may operate as part of a broadband wireless access (BWA) network communication network, such as a Worldwide Interoperability for Microwave Access (WiMAX) communication network or a 3^{rd} Generation Partnership Project (3GPP) Universal Terrestrial Radio Access Network (UTRAN) or a Long-Term-Evolution (LTE) communication network or an LTE-Advanced communication network or a fifth generation (5G) LTE communication network or a high speed downlink/uplink access (HSDPA/HSUPA) communication network, although the scope of the invention is not limited in this respect.

As above, MTC is an emerging technology that may use lower cost and complexity devices with limited resources and battery life. MTC-based applications may include, for example, smart metering, healthcare monitoring, remote security surveillance, and intelligent transportation system, although the scope of the embodiments is not limited in this respect. Many existing mobile broadband networks, such as LTE and LTE-Advanced, are at present optimized for user-oriented UEs rather than being designed or optimized to meet MTC-related requirements, which may instead focus on a lower device cost, enhanced coverage and reduced power consumption. One manner of reducing cost and power consumption of MTC UEs may be to reduce the bandwidth to 1.4 MHz (or less), which corresponds to 6 physical resource blocks (or fewer), in uplink and downlink communications (in one or both of baseband and RF) with the serving cell (eNB). This is compared with the current downlink bandwidth of the broadband system, which may be from 20 MHz to 100 MHz with higher bandwidths likely in the future.

To this end, in one embodiment, narrowband regions may be established within the broadband system bandwidth such that UEs with reduced bandwidth support (hereinafter referred to as narrowband UEs) can be served within the narrowband regions. In one embodiment, the narrowband UEs may be unable to communicate over the wider bandwidth range, while in other embodiments the narrowband UEs may elect not to communicate over the wider bandwidth under most circumstances, as described in more detail below. The narrowband UEs may have a frequency range that spans 1.4 MHz, for example, although this is not a requirement as other narrowband frequency bandwidths may also be used (e.g., ranging from 2.8 MHz or more to 0.7 MHz and less). One example of narrowband UEs may be MTC UEs. Depending on deployment, the number of narrowband UEs being served by the eNB, and amount of uplink and downlink traffic from the eNB, multiple narrowband regions may be defined within the system bandwidth for both uplink and downlink communications. Different narrowband UEs may communicate over different sets of subbands. For narrowband UEs, the set of subbands in the narrowband regions (also referred to as narrowband subbands) over which the UE may communicate may be limited and may not span the entire downlink bandwidth of the broadband system.

Channel State Information (CSI) measurements may be used to estimate the channel quality. CSI measurements may measure Cell-specific Reference Signals (CRS), CSI Reference Signals (CSI-RS) or other Channel State Information-Interference Measurement (CSI-IM) signals transmitted by the eNB for measurement purposes. From the measurements, calculations of the channel quality may be subsequently determined and reported to the eNB. The CSI report may include a Channel Quality Indicator (CQI) and may be sent from the narrowband UE to the eNB to indicate a suitable downlink transmission data rate, i.e., a Modulation and Coding Scheme (MCS) value, for communications with the narrowband UE. The information provided by the CQI may include both channel quality and desired transport block size. The CQI may be, for example, a 4-bit integer (i.e., 15 different values) and may be based on an observed signal-to-interference-plus-noise ratio (SINR) at the narrowband UE. The CQI may take into account the UE capability, such as the number of antennas and the type of receiver used for detection, which may be then used by the eNB to select an optimum MCS level for DL scheduling and data transmission. The CSI and CQI may be reported either periodically or aperiodically. A periodic CQI report may be carried by using the PUCCH or, if the narrowband UE is to send UL data in the same subframe as a scheduled periodic CQI report, the periodic CQI report may instead use the PUSCH. A periodic CQI report may be supplemented by an aperiodic CQI report, in particular if UL data is scheduled during the same subframe as a scheduled periodic CQI report.

In some embodiments, described in more detail below in relation to the measurement gap, a narrowband UE is able to measure subbands throughout the entire (or a substantial portion of the entire) downlink channel bandwidth. In this case, the CQI reports for the entire bandwidth may have different granularities. For example, the CQI report may be a wideband report that provides one CQI value for the entire bandwidth. The CQI value may be a single 4-bit integer that represents an effective SINR over the entire channel bandwidth. This may mask variations in the SINR across the channel and thus may not be adequately used to optimize the signal over subbands with high SINR. Alternatively, the CQI report may be a limited report in which subbands may be selected by the narrowband UE, or by the network using higher layer signaling. The UE-selected subband CQI report may divide the system bandwidth into multiple subbands, select a set of preferred subbands (e.g., the best n adjacent Physical Resource Blocks (PRBs) where n can be 2, 3, 4, 6, or 8 depending on the channel bandwidth and the CQI feedback mode), and then report one CQI value for the wideband and one differential CQI value for the set (assuming transmission only over the selected subbands). The higher layer-configured subband report may provide the highest granularity as it may divide the entire system bandwidth into multiple subbands, then report one wideband CQI value and multiple differential CQI values, one for each subband. As measurement and feedback of the CSI include the CQI, the terms may be used interchangeably in different places herein.

As specified in 3GPP TS 36.213, the set of subbands evaluated for CQI reporting spans the entire downlink bandwidth, where a subband is a set of k contiguous physical resource blocks in which k is a function of the system bandwidth. The number of subbands for the system bandwidth, given by N_{RB}^{DL}, is defined by N=┌N_{RB}^{DL}/k┐. Thus, the reference signal sequence (for the CRS and CSI-RS) may be mapped in a contiguous fashion spanning the entire downlink bandwidth. The CQI values (indices) may be based, for example, on an unrestricted observation interval in time and frequency. The highest CQI index (between 1 and 15) that satisfies a particular condition, or CQI index 0 if the condition is not satisfied, may be reported for the eNB to evaluate the channel. The condition may be for a single PDSCH transport block with a combination of modulation scheme and transport block size corresponding to the CQI index, and occupying the CSI reference resource downlink physical resource blocks, to be received with a transport block error probability not exceeding 0.1. If the CSI subframe sets (both those satisfying the condition and those not satisfying the condition) are configured by higher layers, each CSI reference resource may belong to either, but not both, CSI subframe sets. When the CSI subframe sets are configured by higher layers, the UE may receive a trigger for subframes in which the CSI reference resource that belongs to either subframe set and not receive a trigger for other subframes. In one embodiment, for a UE in transmission mode 10 in which periodic CSI reporting occurs, the CSI subframe set for the CSI reference resource may be configured by higher layers for each CSI process.

Narrowband UEs, however, may be not have the capability or desire (for power conservation purposes) to take such CSI measurements and report the information to the eNB as the CSI measurements generally may be expected by the eNB to be taken over subbands outside of the range of operation of the narrowband UE. Moreover, the subbands may not currently be defined by the RAN for a downlink bandwidth limited to that of the narrowband UEs (e.g., 1.4 MHz). It may thus be desirable, in taking CSI measurements, to provide the appropriate behavior for narrowband UEs using resources that are limited to communicating using subbands in a bandwidth in which the narrowband UE operates. Consequently, the UEs may be provided by the eNB physical resource block indices for a specific, narrowband, region that is within the bandwidth in which the narrowband UE operates, relative to the downlink system bandwidth, on which to perform channel estimation on the CRS and CSI-RS resource elements occurring within the narrowband region. In other embodiments in which the narrowband UE is able to take measurements over multiple sets of subbands, the eNB may indicate to the narrowband UE which subbands to monitor for downlink control and data for one or more subframes. This may also permit the eNB to dynamically assign the narrowband region (i.e., different sets of subbands at different times to different UEs) through signaling with the narrowband UE. In various embodiments, as discussed below, the eNB may limit resource assignment from all subbands within the entire downlink channel to subbands within the narrowband region or the resource assignment may itself be limited by the system to those within the narrowband region such that the eNB may only be able to allocate resources to subbands within the narrowband region.

To this end, in some embodiments, only reduced bandwidth-wideband CSI feedback, which includes at least a CQI, may be defined for narrowband UEs. This is to say that measurements for CSI calculation and reporting may be limited in the frequency dimension to the extent of the subbands in the narrowband region instead of using the entire downlink bandwidth.

In various embodiments, the narrowband region may include frequency hopping across slots, subframes or frames. In this case, in some embodiments, time restrictions may be based on CSI measurement sets such that the CSI calculations use a single set of contiguous subbands. Alternately, the CSI calculation may take into account all CSI measurement sets and thus be unrestricted in time.

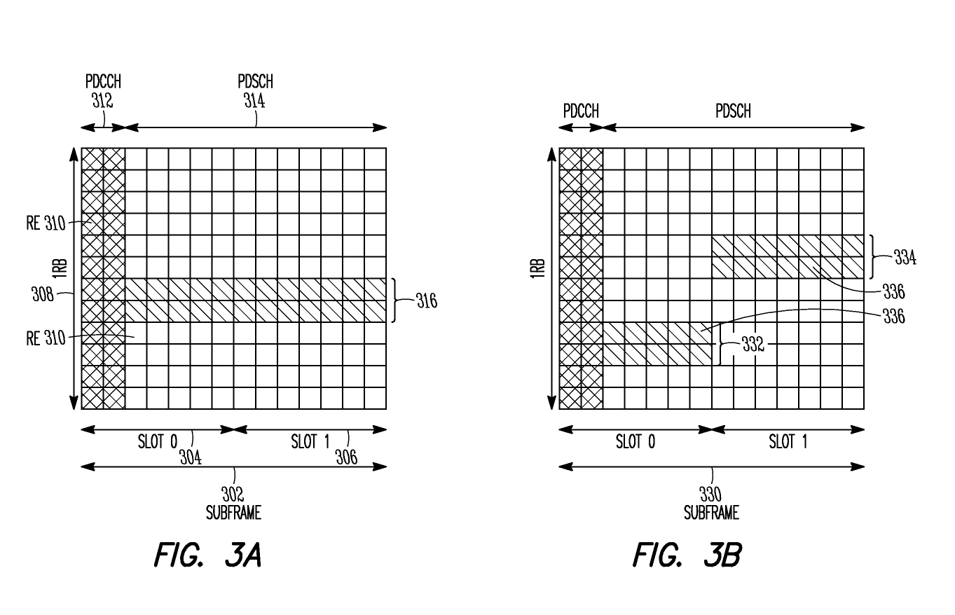

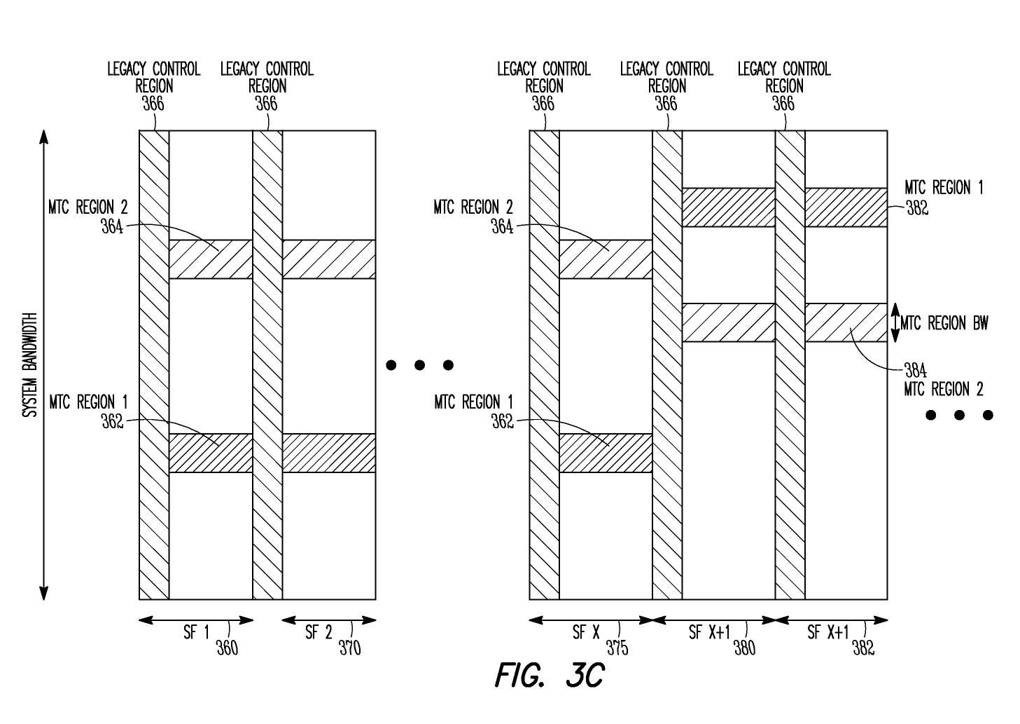

FIGS. 3A-3C illustrate resource blocks in accordance with some embodiments. FIGS. 3A and 3B illustrate resource blocks in a subframe in accordance with some embodiments. The subframe 302 of FIG. 3A contains two slots 304, 306 with resource elements 310. The first one or two symbols of slot 0 304 contains the PDCCH while the remaining symbols of slot 0 304 and slot 1 306 contain the PDSCH. As shown in FIG. 3A, the narrowband region 316 in the subframe 302 contains a single set of contiguous subbands. The narrowband region 316 may extend through multiple subframes. Thus, no frequency hopping is present in the narrowband region 312 in an embodiment in which the narrowband region 316 encompasses only the subframe 302. However, as the narrowband region 316 may span more than one subframe (having multiple narrowband sub-regions as described in more detail below), if frequency hopping is present in the narrowband region 316, the boundary between frequency hopping regions (each of which contains a single set of contiguous subbands) may occur between the subframe 302 and another subframe of the narrowband region 316 (not shown).

FIG. 3B shows an embodiment in which the narrowband region 336 in the subframe 330 contains frequency hopping such that two sets of contiguous subbands 332, 334 are present in the subframe 302. As shown, the sets of contiguous subbands 332, 334 may or may not contain the same number of resource elements, differing in time (number of symbols), frequency (number of subbands), or both. A switching time may be present at the frequency hopping boundary to permit the narrowband UE to tune to the new RF frequency.

Although only one frequency hopping is shown in FIG. 3B, as above, the narrowband region 336 may extend across multiple subframes and may frequency hop at any slot, subframe and/or frame boundary. One example is shown in FIG. 3C, which illustrates frequency hopping every X subframes, instead of at a slot-level. As shown in FIG. 3C, each of X contiguous subframes including subframe 1 360, subframe 2 370, . . . up to subframe X contains multiple MTC regions 362, 364 and legacy control regions 366 in which the MTC regions 362, 364 occur in the same relative frequency locations. Starting at subframe X+1 370, the MTC regions 382, 384 may frequency hop by different amounts from the MTC regions 362, 364 of the previous subframes, as shown, or by the same amount within the system bandwidth. For MTC UEs, the frequency hopping may be limited to the narrowed bandwidth response of the MTC UE. The MTC regions 382, 384 of subframe X+1 370, subframe X+2 380 (which also contain the legacy control regions 366) may occur in the same relative frequency locations. The number of subframes containing the same set of MTC regions (e.g., the subframes containing MTC regions 362, 364 and the subframes containing MTC regions 382, 384) may be the same or may differ. Note that in FIGS. 3A-3C, the retuning time for the UE to switch its carrier frequency from that corresponding to one narrowband frequency location to another is not explicitly shown.

In some embodiments, measurements for CSI calculation and reporting may be limited in the time dimension to only include narrowband subframes, i.e., those subframes that belong to the narrowband region, rather than all downlink subframes. In some embodiments, the narrowband subframes may include only contiguous subframes, while in other embodiments the narrowband subframes may include non-contiguous subframes. For the latter case, the narrowband subframes that form the narrowband region may be signaled by the eNB in a UE-specific or cell-specific manner using a bitmap. The CSI reference resource may thus be limited in frequency to the physical resource blocks within the narrowband region. Consequently, the CQI definition for narrowband UEs may be based on an unrestricted observation interval in time within the set of narrowband subframes that belong to the narrowband region and a restricted observation interval in frequency so as to only include the physical resource blocks within the narrowband region. This is to say that the CQI definition in this embodiment may take into account measurements for any number of the set of narrowband subframes so long as only the narrowband subbands are measured.

In another embodiment, the set of subbands used to calculate the CSI, which may not be defined presently by RAN for the narrowband UE bandwidth (one example of which is 1.4 MHz or 6 physical resource blocks), may be redefined by the eNB to a single set of subbands spanning the bandwidth of the narrowband region for narrowband UEs, irrespective of the downlink bandwidth. In other embodiments, the eNB may provide to the narrowband UE an indication of the physical resource block indices for the narrowband region(s), relative to the downlink bandwidth for measurements on CSI-RS and CSI-IM (for LTE transmission mode 10).

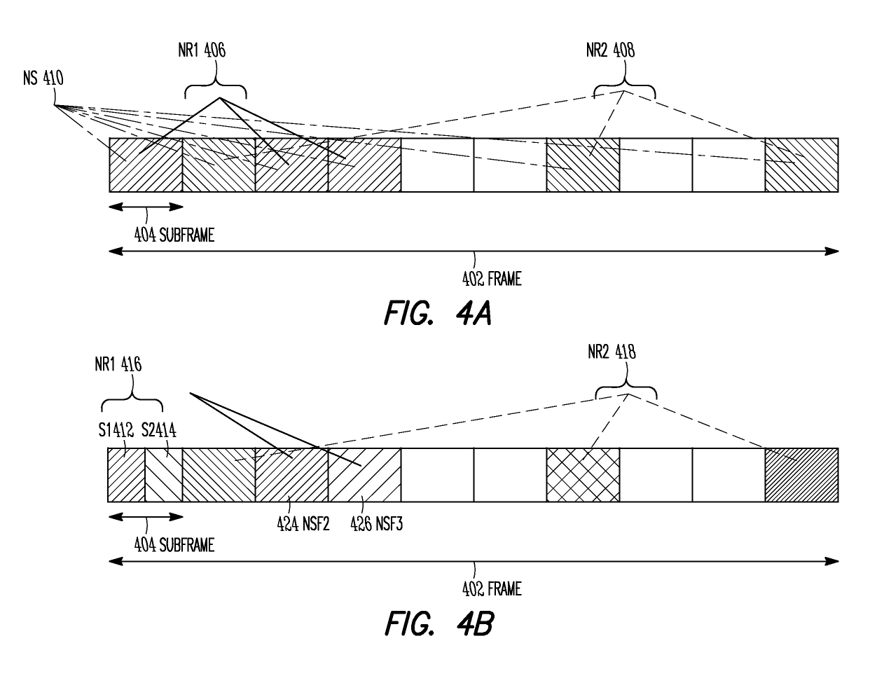

FIGS. 4A and 4B illustrate a frame in accordance with some embodiments. As shown in FIG. 4A, the frame 402 contains 10 subframes 404 of which some, but not all, are associated with narrowband regions NR1 406, NR2 408. As can be seen, the narrowband subframes 410 that form each of narrowband regions NR1 406, NR2 408 may contain either or both contiguous or non-contiguous subframes 404. In particular, as shown, in the frame 402 narrowband region NR1 406 may contain both contiguous and non-contiguous subframes 404, while narrowband region NR2 408 may contain only non-contiguous subframes 404. In FIG. 4A, the narrowband region NR1 406 and narrowband region NR2 408 may be at least partially interleaved such that at least some of the narrowband subframes of the narrowband region NR1 406 surround at least some of the narrowband subframes of the narrowband region NR2 408 in the frame 402. As above, although not shown, the narrowband region NR1 406 and/or narrowband region NR2 408 may extend into another, contiguous or non-contiguous frame, in which the same or different subbands may be measured.

FIG. 4B illustrates an embodiment of the same frame 402 but shows frequency hopping within the narrowband regions. The first narrowband region NR1 416 may comprise a narrowband subframe set that includes narrowband subframes NSF1 422, NSF2 424, NSF3 426. As shown in FIG. 4B, frequency hopping may occur between slot 0 412 and slot 1 414 of the first narrowband subframe NSF1 422 of the first narrowband region NR1 416, as well as between the narrowband subframes NSF1 422, NSF2 424, NSF3 426 of the first narrowband region NR1 416. Although not shown here, frequency hopping can be configured also between a set of X consecutive narrowband subframes where X is greater than 1. As indicated in FIG. 4B, the subbands measured in the slot 0 412 of the first narrowband subframe NSF1 422 is the same as the subbands measured in the second narrowband subframe NSF2 424, both of which differ from the subbands measured in the third narrowband subframe NSF3 426. The subframe sets of the narrowband regions NR1 416, NR2 418 may correspond to different narrowband sub-regions that are non-overlapping in time and span non-overlapping or partially overlapping frequency resources within the downlink bandwidth. Thus, as the frequency hopping between the slot 1 414 of the first narrowband subframe NSF1 422 and the second narrowband subframe NSF2 422 may adjust to the subbands measured in the slot 0 412 of the first narrowband subframe NSF1 422, the time periods for CSI measurement of the narrowband bandwidth may be the same or may differ among the subbands.

A narrowband region may be a set of physical resources that may be defined logically in terms of both frequency and time dimensions such that the span of the resources in the frequency dimension do not exceed a predefined bandwidth (i.e., a number of contiguous physical resource blocks) and different sets of contiguous physical resource blocks can be configured for the UE to monitor for and receive physical downlink channels and signals on different non-overlapping time resources. A narrowband region may be defined only in terms of its span in the frequency dimension, and, a narrowband region may coincide with a narrowband sub-region. A subband or narrowband subband is a narrowband sub-region or narrowband region with respect to the extent of the physical resources in frequency dimension only.

As shown in FIG. 4B, the subbands measured in the slot 0 412 of the first narrowband subframe NSF1 422 may be the same as the subbands measured in the second narrowband subframe NSF2 424, both of which may differ from the subbands measured in the third narrowband subframe NSF3 426. The second narrowband region NR2 418 may also comprise a plurality of narrowband subframes, each of which may measure a different set of subbands such that the measurement times for the sets of subbands are measured for the same amount of time. The narrowband regions may thus each be divided into N narrowband sub-regions that are non-overlapping in time and partially overlapping or non-overlapping in frequency, where N denotes the amount of frequency hopping and can take on any integer value. The rate of frequency hopping may depend on and include the amount of retuning time for the narrowband UEs to switch from one frequency region to another frequency region within the eNB bandwidth. These frequency regions or narrowband sub-regions may be, for example, 1.4 MHz. In another embodiment, as a special case of the above definition of the narrowband region, the narrowband region may be defined only in terms of the frequency dimension and include a single contiguous frequency region spanning, for example, 1.4 MHz. Additionally, frequency hopping may be explicitly configured or predefined such that the UE monitors and receives physical downlink channels and signals on different narrowband regions on different time resources following an eNB-signaled or specified frequency hopping pattern. Thus, frequency hopping may occur at at least one of a boundary between adjacent slots in a subframe, a boundary between adjacent subframes in a frame, a boundary between adjacent sets of subframes in a frame and a boundary between adjacent radio frames such that a contiguous set of subcarriers within adjacent boundaries is used for monitoring for and reception of physical downlink channels and signals by the UE and measurements of the for CSI computation, and includes any retuning time used by the UE to switch from one narrowband sub-region to another within the system bandwidth.

In one embodiment, the CSI measurements for derivation of the CQI and reporting may be time-restricted to each of the narrowband sub-regions. In one embodiment, the narrowband UE may not filter or average across different narrowband sub-regions that occur on different frequency locations. Thus, as seen in FIG. 4B for example, the narrowband UE may filter or average across slot 0 412 of the first narrowband subframe NSF1 422 and the second narrowband subframe NSF2 424 of the first narrowband region NR1 416 but not with any other portion of the first narrowband region NR1 416 or the second narrowband region NR2 418. Such narrowband-specific CSI feedback can provide the eNB with CSI corresponding to the individual narrowband sub-regions for the UE and facilitate benefits from downlink link adaptation for frequency-selective scheduling.

Thus, different subframe sets may be defined in which subframe set k (0≦k<N) is the set of subframes belonging to narrowband sub-region k. For derivation of the CQI, the CSI reference resource in a given downlink subframe may belong to only one subframe set, and the CQI reporting mechanism can be associated with a specific CSI reference resource.

The CQI definition for narrowband UEs may, in one embodiment, be based on an unrestricted observation interval in time within the set of narrowband subframes belonging to the narrowband region, and a restricted observation interval in frequency to limit the observations to the physical resource blocks within the narrowband sub-regions. The narrowband UEs may derive a single CQI value based on observations on at least one of the CRS, CSI-RS, or CSI-IM spanning the narrowband region, which, as above is composed of narrowband sub-regions spanning non-overlapping or partially overlapping frequency resources within the downlink bandwidth. In another embodiment, while the CQI definition may be based on unrestricted observations in time within the set of narrowband subframes belonging to the narrowband region, as above, in this embodiment, the CQI definition may be based on an unrestricted observation interval in frequency. Unlike the above embodiments, this latter embodiment may permit averaging over subbands that are outside of the narrowband subbands to derive CQI values that are based on a greater amount of averaging of the channel in the frequency dimension than the more limited narrowband averaging. This wide-band CQI uses channel information with the effect of fast fading being at least partially) averaged out, e.g., frequency-selective fading can be averaged out. It also increases the reliability of the CQI feedback especially when the narrowband subband goes through a deep fade or the narrowband UE is in a deep coverage hole. In such cases, the eNB may not perform frequency-selective scheduling but instead perform scheduling and conservative link adaptation based on the “average condition of the link.”

As above another embodiment, the set of subbands used to calculate the CSI, which may not be defined presently by RAN for the narrowband UE bandwidth, may be redefined by the eNB to include only the narrowband subbands spanning the bandwidth of the narrowband region for narrowband UEs, irrespective of the downlink bandwidth. Thus, for narrowband UEs the set of narrowband subbands may include only the physical resource blocks corresponding to the physical sub-region depending on to which CSI subframe set the CSI reference resource belongs.

Further, multiple narrowband regions may be defined within the downlink bandwidth. In one cell-specific embodiment, the eNB may assign the narrowband UEs served by the eNB with CSI resources on the same narrowband region. In another UE-specific embodiment, the eNB may assign different narrowband resources to different the narrowband UEs served by the eNB. In the latter case, the narrowband resources may overlap in frequency among the narrowband UEs served by the eNB. Thus, the interpretation of the set of narrowband subbands may differ among the narrowband UEs served by the eNB. In either embodiment, different eNBs may assign narrowband resources to the UEs differently.

In another embodiment, the narrowband UE may maintain the same definition of the set of narrowband subbands used to evaluate the CSI, the CQI definition, and the CQI feedback, for example. In this embodiment, the narrowband UE may be allowed to measure the CSI on the subbands not configured for the narrowband UE during the measurement gap. Generally, the measurement gap may allow a narrowband UE that is incapable of simultaneous detection of multiple channels to not receive data from the serving cell during the measurement gap, so the narrowband UE can perform inter-frequency RRM measurements on carrier frequencies different from the serving cell carrier frequency (e.g., E-UTRAN FDD and TDD, UTRAN FDD, GERAN, LCR TDD, HRPD, CDMA2000 1×). The measurement gap may include a switching time for frequency adjustment as well as time to perform a CQI measurement. In various embodiments, the measurement gap may have a predetermined length, for example 2 ms, 10 ms or 11 ms, during which narrowband UE may perform CSI measurements for another frequency within the system bandwidth of the serving cell less the switching time. Assuming the switching time is 1 ms, the narrowband UE may measure the CQI for 1 ms, 9 ms and 10 ms, respectively. In addition, the measurement gap may occur relatively infrequently, e.g., for the above examples, 40 ms, 100 ms, and 200 ms. In other embodiments, the narrowband UE may perform both CSI measurements and inter-frequency RRM measurements during a single instance of a measurement gap.

For each of the CRS and CSI-RS, the reference signal sequence may be mapped in a contiguous fashion spanning the entire eNB bandwidth. To derive the reference signal sequences for the CRS and CSI-RS corresponding to the physical resource blocks within the monitored narrowband region, the narrowband UE may be provided by the eNB with the physical resource block indices for the narrowband region. Accordingly, assuming that the narrowband UE is aware of the downlink bandwidth, the configuration of the narrowband region may include the physical resource block indices relative to the downlink bandwidth for the narrowband region.

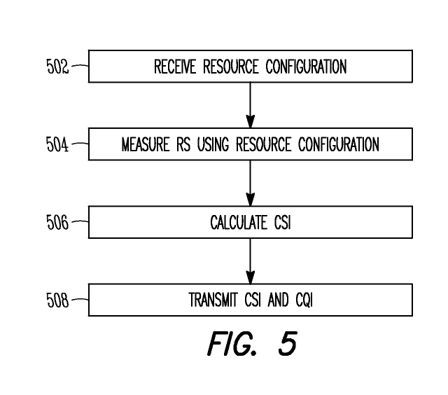

FIG. 5 illustrates a flowchart of a method of providing channel feedback in accordance with some embodiments. In operation 502, the narrowband UE may receive a resource configuration from the eNB related to monitoring for and reception of physical downlink control and data channels and CSI measurements. The resource configuration may be for a set of contiguous physical resource blocks in the bandwidth range of the UE, which may be reduced compared with the entire downlink system bandwidth. The narrowband UE configuration for monitoring of downlink physical channels and performing downlink measurements may be 1.4 MHz (6 physical resource blocks) or less.

At operation 504, the narrowband UE may measure reference signals on the allocated resources. The reference signals may be CRS or CSI-RS transmitted by the eNB using the allocated resources. The measurements may occur on physical resource blocks that are contiguous but may be restricted in frequency to only those physical resource blocks in a frequency range supported by the narrowband UE. The measurements may be unrestricted in time and may take place over one or more slots, subframes, or frames.

At operation 506, the narrowband UE may calculate the CSI based on the measurements. The calculation may be averaged over a preset time period using one set of subbands to provide a CSI measurement and CQI value for that set of subbands. Alternately, the calculation may include multiple sets of narrowband subbands and provide a CSI measurement and CQI value for each set of narrowband subbands or a single CSI measurement and CQI value averaged over all of the sets of narrowband subbands. If multiple sets of subbands are measured, the frequency hopping boundary may occur between adjacent slots, subframes or frames. The frequency may hop between the sets of narrowband subbands in different time regions. The measurements for the CQI calculation may be limited to only include subframes that belong to a narrowband region. This is to say that the eNB may instruct the narrowband UE to take measurements and limit the allocation to only time regions in which measurements of the narrowband subbands are to be taken by UEs, irrespective of the UE type. Alternately, the eNB may instruct the narrowband UE to take measurements in which only narrowband subbands are to be measured.

At operation 508, the narrowband UE may transmit the CSI and CQI to the eNB. The measurements may be transmitted as the calculations by the narrowband UE are completed. Alternately, the measurements may be combined by the narrowband UE so that multiple measurements of different sets of subbands within the narrowband UE frequency spectrum may all be sent at a predetermined time, such as at a particular subframe within the next frame after the measurements are taken and calculations completed.

Note that although the proposed design use the exemplary system bandwidth of 1.4 MHz, the design may be further extended to other narrow bandwidth scenarios, e.g. 200 kHz, 400 kHz, etc. In addition, the MTC is used as the initial target application for the proposed narrow-band design, the design maybe be extended to other narrow-band deployed applications, e.g. Device-to-Device, Internet of Things (IoT), etc.

In Example 1, a UE comprises transceiver configured to communicate with an eNB and processing circuitry. The processing circuitry is configured to: provide reduced bandwidth support of at most six physical resource blocks; configure the transceiver to receive a resource assignment on which to take measurements indicating a narrowband region comprising a reduced bandwidth that is supported by the UE and free from subbands outside of the narrowband region; configure the transceiver to take measurements of downlink transmissions using the assigned resources, the measurements limited to subbands included within the narrowband region; calculate Channel State Information (CSI) based on the measurements; and report a region-specific wideband CSI that includes at least a region-specific wideband Channel Quality Indicator (CQI) to the eNB.

In Example 2, the subject matter of Example 1 can optionally include either or both of the processing circuitry being configured to configure the transceiver to receive the resource assignment from the eNB or the resource assignment being pre-configured in the UE.

In Example 3, the subject matter of one or any combination of Examples 1-2 can optionally include the processing circuitry being configured to calculate the CSI based on an unrestricted interval in time within a predetermined set of subframes of the narrowband region and a restricted interval in frequency that is free from physical resource blocks outside the narrowband region.

In Example 4, the subject matter of one or any combination of Examples 1-3 can optionally include the processing circuitry being configured to define the narrowband region logically to comprise a plurality of physical sub-regions and map logical-to-physical resources of the narrowband region to include frequency hopping.

In Example 5, the subject matter of Example 4 can optionally include a logical definition of the narrowband region being one of: indicated to the UE by the eNB via UE-specific or cell-specific signaling, and pre-defined in the UE as a function of the system bandwidth.

In Example 6, the subject matter of Example 4 can optionally include the frequency hopping being configured to occur at at least one of a boundary between adjacent slots in a subframe, a boundary between adjacent subframes in a frame, a boundary between adjacent sets of subframes in a frame and a boundary between adjacent radio frames such that a contiguous set of subcarriers within adjacent boundaries is used for monitoring for and reception of physical downlink channels and signals by the UE and measurements for CSI computation, and includes any retuning time used by the UE to switch from one narrowband sub-region to another within a system bandwidth.

In Example 7, the subject matter of Example 4 can optionally include the processing circuitry being configured to calculate the CSI based on an unrestricted interval in time within a CSI subframe set and a restricted interval in frequency that is free from physical resource blocks in physical sub-regions other than physical sub-regions corresponding to the CSI subframe set, and CSI subframe set k (0≦k<N) comprising a set of subframes of physical sub-region k, N is a total number of physical sub-regions that comprise the narrowband region and are non-overlapping in time and span one of non-overlapping and partially overlapping frequency resources within the downlink bandwidth, and k and N are both integers.

In Example 8, the subject matter of Example 4 can optionally include that the CSI is measured on a CSI reference resource, and the CSI reference resource in a given downlink subframe belongs to at most one of the CSI subframe sets.

In Example 9, the subject matter of Example 4 can optionally include the processing circuitry being configured to calculate the CSI based on an unrestricted interval in time within a predetermined or eNB-signaled set of subframes of the narrowband region and a restricted interval in frequency that is free from physical resource blocks outside of the physical sub-regions corresponding to the respective subframe.

In Example 10, the subject matter of Example 4 can optionally include the processing circuitry being configured to calculate the CSI based on an unrestricted interval in time within a predetermined or eNB-signaled set of subframes of the narrowband region and an unrestricted interval in frequency.

In Example 11, the subject matter of Example 4 can optionally include the UE being configured with a measurement gap that may span at least one downlink subframe, and the processing circuitry being configured to configure the transceiver to avoid monitoring for and receiving physical downlink channels during the measurement gap.

In Example 12, the subject matter of Example 4 can optionally include the processing circuitry being configured to measure CSI on frequency locations on which the UE is not configured to monitor for and receive physical downlink control and data channels during the measurement gap.

In Example 13, the subject matter of one or any combination of Examples 1-12 can optionally include the processing circuitry being configured to evaluate a set of subbands for CQI reporting, and the set of subbands spanning a single contiguous frequency band within the downlink bandwidth irrespective of the downlink bandwidth and includes a set of physical resource blocks that comprise a physical sub-region corresponding to a given subframe.

In Example 14, the subject matter of one or any combination of Examples 1-13 can optionally include that the narrowband region includes an indication of indices of physical resource blocks relative to the downlink bandwidth to enable measurements and channel estimation on Cell-specific Reference Signals (CRS), Channel State Information Reference Signals (CSI-RS) and Channel State Information-Interference Measurement (CSI-IM) resources.

In Example 15, the subject matter of one or any combination of Examples 1-14 can optionally include that the UE is a Machine Type Communication (MTC) UE having a reduced bandwith of at most 1.4 MHz in both downlink and uplink, and the downlink bandwidth of the eNB is at least 1.4 MHz.

In Example 16, the subject matter of one or any combination of Examples 1-14 can optionally include an antenna configured to provide communications between the transceiver and the eNB.

Example 17 a method for Channel State Information (CSI) measurement and reporting, the method comprises: receiving, at user equipment (UE) configured to communicate over a bandwidth smaller than a downlink bandwidth of an evolved Node-B (eNB), a resource configuration information from the eNB, the resource configuration information indicating a narrowband region that is compatible with the bandwidth supported by the UE and free from subbands outside of the narrowband region; taking measurements on at least one of Cell-specific Reference Signals (CRS), Channel State Information Reference Signals (CSI-RS) and Channel State Information-Interference Measurement (CSI-IM) resources using the assigned resources, the measurements limited to subcarriers included within the narrowband region; and calculating the CSI based on the measurements.

In Example 18, the subject matter of Example 17 can optionally include that the measurements are taken during an unrestricted interval in time anywhere within a predetermined or eNB-signaled set of subframes of the narrowband region.

In Example 19, the subject matter of one or any combination of Examples 17-18 can optionally include that the narrowband region is defined logically to comprise a plurality of physical sub-regions, and the narrowband region comprises frequency hopping that occurs at frame structure boundaries such that a continuous set of subcarriers within adjacent boundaries is used for the monitoring for and reception of physical downlink channels and signals by the UE and measurements for CSI computation, and includes any retuning time used by the UE to switch from one narrowband sub-region to another within a system bandwidth.

In Example 20, the subject matter of Example 19 can optionally include that the measurements are taken during an unrestricted interval in time anywhere within a particular CSI subframe set and a restricted interval in frequency that is free from physical resource blocks in physical sub-regions other than physical sub-regions corresponding to the particular CSI subframe set, and CSI subframe set k (0≦k<N) comprises a set of subframes of physical sub-region k, N is a total number of physical sub-regions that comprise the narrowband region and are non-overlapping in time and span one of non-overlapping and partially overlapping frequency resources within the downlink bandwidth, and k and N are both integers.

In Example 21, the subject matter of one or any combination of Examples 17-20 can optionally include preventing monitoring for and reception of physical downlink control and data channels during a measurement gap that exists to facilitate CSI measurements by a UE with reduced bandwidth support on frequency locations within the downlink system bandwidth that are different from the narrowband sub-region that the UE is configured to monitor for and receive physical downlink control and data channels.

In Example 22, the subject matter of one or any combination of Examples 17-21 can optionally include a set of subbands evaluated for Channel State Information (CSI) reporting, that includes at least Channel Quality Indicator (CQI) reporting spans a contiguous frequency band within the downlink bandwidth irrespective of the downlink system bandwidth and includes a set of physical resource blocks that comprise a physical sub-region corresponding to a given subframe.

Example 23 comprises a non-transitory computer-readable storage medium that stores instructions for execution by one or more processors of user equipment (UE) to communicate with an evolved Node-B (eNB). The one or more processors to configure the UE to: limit communication with the eNB to a bandwidth smaller than a downlink bandwidth of the eNB; receive a resource assignment from the eNB, the resource assignment indicating a narrowband region that is compatible with the bandwidth supported by the UE and free from subbands outside of the narrowband region; perform measurements on the assigned resources, the measurements limited to subcarriers included within the narrowband region and free from time restrictions within the narrowband region; calculate Channel State Information (CSI) based on the measurements; and report a region-specific wideband CSI that includes at least a region-specific wideband Channel Quality Indicator (CQI) to the eNB.

In Example 24, the subject matter of Example 23 can optionally include that the narrowband region is defined logically to comprise a plurality of physical sub-regions, and the narrowband region comprises frequency hopping that occurs at frame structure boundaries such that a continuous set of subcarriers within adjacent boundaries is used for the monitoring for and reception of physical downlink channels and signals by the UE and measurements for CSI computation, and includes any retuning time used by the UE to switch from one narrowband sub-region to another within a system bandwidth.

In Example 25, the subject matter of one or any combination of Examples 23-24 can optionally include that the measurements are taken during a time interval free from restriction within a particular CSI subframe set and a restricted interval in frequency that is free from physical resource blocks in physical sub-regions other than physical sub-regions corresponding to the particular CSI subframe set, and CSI subframe set k (0≦k<N) comprises a set of subframes of physical sub-region k, N is a total number of physical sub-regions that comprise the narrowband region and are non-overlapping in time and span one of non-overlapping and partially overlapping frequency resources within the downlink bandwidth, and k and N are both integers.

In Example 26, the subject matter of one or any combination of Examples 23-25 can optionally include the one or more processors further configure the UE to avoid receiving downlink transmissions during a measurement gap that exists to facilitate CSI measurements by a UE with reduced bandwidth support on frequency locations within the downlink system bandwidth that are different from the narrowband sub-region that the UE is configured to monitor for and receive physical downlink control and data channels.

In Example 27, the subject matter of one or any combination of Examples 23-26 can optionally include that a set of subbands evaluated for the CQI reporting spans a single contiguous frequency band within the downlink bandwidth irrespective of the downlink bandwidth and includes a set of physical resource blocks that comprise a physical sub-region corresponding to a given subframe.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. User equipment (UE) comprising:
transceiver circuitry configured to communicate with an evolved Node-B (eNB); and
processing circuitry configured to:
provide reduced bandwidth support of at most six physical resource blocks;
configure the transceiver to receive a resource assignment on which to take measurements indicating a narrowband region comprising a reduced bandwidth that is supported by the UE and free from subbands outside of the narrowband region;
configure the transceiver to take measurements of downlink transmissions using the assigned resources, the measurements limited to subbands included within the narrowband region;
calculate Channel State Information (CSI) based on the measurements; and
report a region-specific wideband CSI that includes at least a region-specific wideband Channel Quality Indicator (CQI) to the eNB.

2. The UE of claim 1, wherein one of:
the processing circuitry is further configured to configure the transceiver to receive the resource assignment from the eNB, or
the resource assignment is pre-configured in the UE.

3. The UE of claim 1, wherein:
the processing circuitry configured to calculate the CSI based on an unrestricted interval in time within a predetermined set of subframes of the narrowband region and a restricted interval in frequency that is free from physical resource blocks outside the narrowband region.

4. The UE of claim 1, wherein:
the processing circuitry configured to define the narrowband region logically to comprise a plurality of physical sub-regions, and
the processing circuitry configured to map logical-to-physical resources of the narrowband region to include frequency hopping.

5. The UE of claim 4, wherein:
a logical definition of the narrowband region is one of:
indicated to the UE by the eNB via UE-specific or cell-specific signaling, and
pre-defined in the UE as a function of the system bandwidth.

6. The UE of claim 4, wherein:
the frequency hopping is configured to occur at at least one of a boundary between adjacent slots in a subframe, a boundary between adjacent subframes in a frame, a boundary between adjacent sets of subframes in a frame and a boundary between adjacent radio frames such that a contiguous set of subcarriers within adjacent boundaries is used for monitoring for and reception of physical downlink channels and signals by the UE and measurements for CSI computation, and includes any retuning time used by the UE to switch from one narrowband sub-region to another within a system bandwidth.

7. The UE of claim 4, wherein:
the processing circuitry configured to calculate the CSI based on an unrestricted interval in time within a CSI subframe set and a restricted interval in frequency that is free from physical resource blocks in physical sub-regions other than physical sub-regions corresponding to the CSI subframe set, and
CSI subframe set k (0≦k<N) comprises a set of subframes of physical sub-region k, N is a total number of physical sub-regions that comprise the narrowband region and are non-overlapping in time and span one of non-overlapping and partially overlapping frequency resources within the downlink bandwidth, and k and N are both integers.

8. The UE of claim 7, wherein:
the CSI is measured on a CSI reference resource, and
the CSI reference resource in a given downlink subframe belongs to at most one of the CSI subframe sets.

9. The UE of claim 4, wherein:
the processing circuitry configured to calculate the CSI based on an unrestricted interval in time within a predetermined or eNB-signaled set of subframes of the narrowband region and a restricted interval in frequency that is free from physical resource blocks outside of the physical sub-regions corresponding to the respective subframe.

10. The UE of claim 4, wherein:
the processing circuitry configured to calculate the CSI based on an unrestricted interval in time within a predetermined or eNB-signaled set of subframes of the narrowband region and an unrestricted interval in frequency.

11. The UE of claim 4, wherein:
the UE is configured with a measurement gap that may span at least one downlink subframe, and
the processing circuitry is further configured to configure the transceiver to avoid monitoring for and receiving physical downlink channels during the measurement gap.

12. The UE of claim 4, wherein the processing circuitry is further configured to:
measure CSI on frequency locations on which the UE is not configured to monitor for and receive physical downlink control and data channels during the measurement gap.

13. The UE of claim 1, wherein:
the processing circuitry configured to evaluate a set of subbands for CQI reporting, and
the set of subbands spans a single contiguous frequency band within the downlink bandwidth irrespective of the downlink bandwidth and includes a set of physical resource blocks that comprise a physical sub-region corresponding to a given subframe.

14. The UE of claim 1, wherein:
the narrowband region includes an indication of indices of physical resource blocks relative to the downlink bandwidth to enable measurements and channel estimation on Cell-specific Reference Signals (CRS), Channel State Information Reference Signals (CSI-RS) and Channel State Information-Interference Measurement (CSI-IM) resources.

15. The UE of claim 1, wherein:
wherein the UE is a Machine Type Communication (MTC) UE having a reduced bandwith of at most 1.4 MHz in both downlink and uplink, and the downlink bandwidth of the eNB is at least 1.4 MHz.

16. The UE of claim 1, further comprising:
an antenna configured to provide communications between the transceiver and the eNB.

17. An apparatus of a user equipment (UE), the apparatus comprising:
processing circuitry configured to:
configure a transceiver to communicate over a bandwidth smaller than a downlink bandwidth of an evolved Node-B (eNB);
configure the transceiver to receive a resource configuration information from the eNB, the resource configuration information indicating a narrowband region that is compatible with the bandwidth supported by the UE and free from subbands outside of the narrowband region;
configure the transceiver to take measurements on at least one of Cell-specific Reference Signals (CRS), Channel State Information Reference Signals (CSI-RS) and Channel State Information-Interference Measurement (CSI-IM) resources using the assigned resources, the measurements limited to subcarriers included within the narrowband region;
calculate the CSI based on the measurements; and
configure the transceiver to report the CSI to the eNB at a predetermined time.

18. The apparatus of claim 17, wherein the processing circuitry is further configured to:
configure the transceiver to take the measurements during an unrestricted interval in time anywhere within a predetermined or eNB-signaled set of subframes of the narrowband region.

19. The apparatus of claim 17, wherein:
the narrowband region is defined logically to comprise a plurality of physical sub-regions, and
the narrowband region comprises frequency hopping that occurs at frame structure boundaries such that a continuous set of subcarriers within adjacent boundaries is used for the monitoring for and reception of physical downlink channels and signals by the UE and measurements for CSI computation, and includes any retuning time used by the UE to switch from one narrowband sub-region to another within a system bandwidth.

20. The apparatus of claim 19, wherein:
the processing circuitry is further configured to configure the transceiver to take the measurements during an unrestricted interval in time anywhere within a particular CSI subframe set and a restricted interval in frequency that is free from physical resource blocks in physical sub-regions other than physical sub-regions corresponding to the particular CSI subframe set, and
CSI subframe set k (0≦k<N) comprises a set of subframes of physical sub-region k, N is a total number of physical sub-regions that comprise the narrowband region and are non-overlapping in time and span one of non-overlapping and partially overlapping frequency resources within the downlink bandwidth, and k and N are both integers.

21. The apparatus of claim 17, wherein the processing circuitry is further configured to:
prevent monitoring for and reception of physical downlink control and data channels during a measurement gap that exists to facilitate CSI measurements by the UE on frequency locations within the downlink system bandwidth that are different from the narrowband sub-region that the UE is configured to monitor for and receive physical downlink control and data channels.

22. The apparatus of claim 17, wherein the processing circuitry is further configured to:
evaluate a set of subbands, for CSI reporting, that includes at least Channel Quality Indicator (CQI) reporting spans a contiguous frequency band within the downlink bandwidth irrespective of the downlink system bandwidth and includes a set of physical resource blocks that comprise a physical sub-region corresponding to a given subframe.

23. A non-transitory computer-readable storage medium that stores instructions for execution by one or more processors of user equipment (UE) to communicate with an evolved Node-B (eNB), the one or more processors to configure the UE to:
limit communication with the eNB to a bandwidth smaller than a downlink bandwidth of the eNB;
receive a resource assignment from the eNB, the resource assignment indicating a narrowband region that is compatible with the bandwidth supported by the UE and free from subbands outside of the narrowband region;
perform measurements on the assigned resources, the measurements limited to subcarriers included within the narrowband region and free from time restrictions within the narrowband region;
calculate Channel State Information (CSI) based on the measurements; and
report a region-specific wideband CSI that includes at least a region-specific wideband Channel Quality Indicator (CQI) to the eNB.

24. The non-transitory computer-readable storage medium of claim 23, wherein:
the narrowband region is defined logically to comprise a plurality of physical sub-regions, and
the narrowband region comprises frequency hopping that occurs at frame structure boundaries such that a continuous set of subcarriers within adjacent boundaries is used for the monitoring for and reception of physical downlink channels and signals by the UE and measurements for CSI computation, and includes any retuning time used by the UE to switch from one narrowband sub-region to another within a system bandwidth.

25. The non-transitory computer-readable storage medium of claim 24, wherein:
the measurements are taken during a time interval free from restriction within a particular CSI subframe set and a restricted interval in frequency that is free from physical resource blocks in physical sub-regions other than physical sub-regions corresponding to the particular CSI subframe set, and
CSI subframe set k (0≦k<N) comprises a set of subframes of physical sub-region k, N is a total number of physical sub-regions that comprise the narrowband region and are non-overlapping in time and span one of non-overlapping and partially overlapping frequency resources within the downlink bandwidth, and k and N are both integers.

26. The non-transitory computer-readable storage medium of claim 24, wherein the one or more processors further configure the UE to:
avoid receiving downlink transmissions during a measurement gap that exists to facilitate CSI measurements by a UE with reduced bandwidth support on frequency locations within the downlink system bandwidth that are different from the narrowband sub-region that the UE is configured to monitor for and receive physical downlink control and data channels.

27. The non-transitory computer-readable storage medium of claim 23, wherein:
a set of subbands evaluated for the CQI reporting spans a single contiguous frequency band within the downlink bandwidth irrespective of the downlink bandwidth and includes a set of physical resource blocks that comprise a physical sub-region corresponding to a given subframe.
